(19) United States
(12) Patent Application Publication
(10) Pub. No.: US 2019/0054785 A1
(43) Pub. Date: Feb. 21, 2019

(54) BEARING ARRANGEMENT FOR A MOTOR VEHICLE

(71) Applicant: FORD GLOBAL TECHNOLOGIES, LLC, Dearborn, MI (US)

(72) Inventor: Joerg KEUSER, Grevenbroich (DE)

(73) Assignee: FORD GLOBAL TECHNOLOGIES, LLC, Dearborn, MI (US)

(21) Appl. No.: 16/051,827

(22) Filed: Aug. 1, 2018

(30) Foreign Application Priority Data
Aug. 15, 2017 (DE) 10 2017 214 190.5

(51) Int. Cl. B60G 7/00; F16C 27/06

(52) U.S. Cl. CPC B60G 7/008; F16C 17/02; F16C 27/063

(57) ABSTRACT

The disclosure relates to a bearing arrangement for a motor vehicle, having a first component with a bearing eye, which a bearing bushing is arranged, a second component with a first and second attaching portion, which are arranged on both sides of the first component in a region of the bearing eye, and a tensioning device, which is guided axially through an inner sleeve of the bearing bushing via a shaft portion to optimize connection of two components via a bearing bushing. The tensioning device tensions the inner sleeve axially against the second attaching portion, avoiding the first attaching portion, and is received with radial form fit in a first recess of the first attaching portion by a head portion.

### CROSS-REFERENCE TO RELATED APPLICATIONS

This application claims foreign priority benefits under 35 U.S.C. § 119(a)-(d) to DE Application 10 2017 214 190.5 filed Aug. 15, 2017, which is hereby incorporated by reference in its entirety.

### TECHNICAL FIELD

The disclosure relates to a bearing arrangement for a motor vehicle.

### BACKGROUND

In a wheel suspension of motor vehicles, such as automobiles or trucks, mutually movable parts are often connected to one another by elastic bearings. In particular, these can be rubber-metal, composite bearings. A corresponding rubber-metal bushing has a metal, inner sleeve, which is concentrically surrounded by a rubber-elastic element and normally by a likewise metal outer sleeve. The inner sleeve is connected to one suspension part and the outer sleeve (or the rubber-elastic element) is connected to another suspension part. Owing to the elasticity of the rubber-elastic element, the two suspension parts are movable with respect to one another to a limited extent. If progression of the inner sleeve defines an axial direction, axial, radial, tangential and cardanic movements are conceivable. Therefore, a bearing of this type can act similarly to a ball joint to a limited extent. Aside from that various degrees of freedom are created by elasticity, the rubber-elastic element also serves to prevent transmission of vibrations, which are undesirable with regard to NVH aspects.

An example of an application for such bearings is a connection of a wheel carrier to a transverse control arm. In this case, for example, the rubber-metal bushing is pressed into a bearing eye in an end portion of a transverse control arm, wherein, in an assembled state, the end portion is arranged between two clevis arms of the wheel carrier. A screw is guided through bores in the clevis arms, and an inner sleeve of the bushing so that a head of a screw lies against one clevis arm. A nut is screwed onto the screw such that it lies against the other clevis arm. During tightening, the clevis arms are tensioned against the inner sleeve by an axial tensioning force that is generated by a combination of a screw and nut. This requires an elastic (and possibly also, partly plastic) deformation of the clevis arms since a clevis arm spacing has to be dimensioned such that the spacing is greater than a length of the inner sleeve in order to enable an introduction of the inner sleeve. An elastic restoring force is therefore generated in each clevis arm, which is opposed to the tensioning force generated by the screw and nut, and reduces a force that is effectively applied between the clevis arm and the inner sleeve. That is to say, the screw and nut have to be designed to be more stable than would actually be necessary for tensioning the inner sleeve. In some circumstances, the force thus generated between the clevis arm and the inner sleeve can even be too low to enable effective tensioning. Deformation of the clevis arms results in a permanent load owing to inner stresses that can reduce a service life of the wheel carrier. Moreover, plastic deformations of the clevis arms, which ultimately result in a reduction in the tensioning force, can eventually occur within the service life of the assembly.

CN 205185755 U discloses a wheel suspension having a wheel carrier and, connected thereto, a front lower control arm and a rear lower control arm. The wheel carrier has two approximately, vertically extending bores, and each of the control arms has a bolt that is received in a bore. The wheel carrier furthermore has a horizontally extending bore that intersects the vertically extending bores. A securing screw is guided into the horizontally extending bore. In this case, a form fit is produced between a securing bolt and a respective annular groove on one of the respective bolts.

US 2004/0094924 A1 discloses a wheel suspension having a wheel carrier and an upper and a lower transverse control arm. For attaching each of the transverse control arms, the wheel carrier has a respective clevis portion. An attaching portion of the respective transverse control arm has a bearing eye, which is arranged between bores within the clevis arm of the respective clevis portion. The attachment can take place via a ball joint or a rubber-metal bushing that is pressed into the bearing eye. In this case, an inner sleeve of the respective bushing is tensioned between the clevis arms via a combination of a flange screw and a flange nut. To enable adjustment of a camber, one of the bores of the respective clevis arm is formed as an elongated hole within which a flange screw can be displaced transversely to its direction of progression when a flange nut is loosened.

US 2013/0149023 A1 discloses an adjustable bell crank system for a turbo engine. The system has a bell crank and a tie rod that are rotatably connected to one another. An end portion of the tie rod having a bearing eye is arranged in a clevis portion of the bell crank, wherein a connection is produced via a ball joint whereof an inner portion is penetrated by an axial pin that extends through two collar elements on sides of the clevis portion. Each collar element is inserted into a circular bore of a clevis arm, and has an eccentrically arranged inner bore into which the axial pin is introduced. In this case, the axial pin has two opposing external threads that cooperate with corresponding internal threads of the collar elements. A rotation of the axial pin results in an axial force on the collar elements, which is transmitted to the clevis arms by radial projections, and tensions these clevis arms against one another.

U.S. Pat. No. 6,648,351 B1 discloses a subframe for a motor vehicle having attaching regions for transverse control arms. To attach an upper transverse arm, a respective projection is provided on both sides of a bracket-like portion, which projections have a bore that, in each case, receives an axial pin on which a respective bearing eye of the transverse control arm is mounted via an interconnected sleeve. In this case, the sleeve is tensioned axially against the projection in each case. The projections can be integrally formed on the bracket-like portion, or they can be formed by a separate component. The bore can optionally pass through both projections, wherein a longitudinal screw is guided through both sleeves and the bore, and tensioned via a nut.

WO 2011/113514 A1 discloses a wheel carrier for a multi-control-arm, individual wheel suspension. This has four attaching points that attach an upper transverse control arm, a rear lower transverse control arm, a front lower transverse control arm and a longitudinal control arm. In this case, an attaching point for attaching the rear lower transverse control arm is formed by a rear joint bolt socket and a front joint bolt socket. In an assembled state, it is provided that a joint bolt is screwed into an internal thread of the rear joint bolt socket until it projects into the front joint bolt socket. In this case, a rubber-metal bushing can be seated on the joint bolt, which rubber-metal bushing is secured in a control-arm eye of a transverse control arm.

A suspension system for a vehicle is disclosed in US 2007/0007741 A1. In this case a wheel carrier is connected to a vehicle frame via an upper and a lower control arm, and a longitudinal control arm. The longitudinal control arm in this case has a flexible blade element that is fastened to the wheel carrier and forms a bracket mount. A track rod is fastened between the frame and the bracket mount. According to one embodiment, a flange screw is guided through bores within the wheel carrier and the bracket mount, and secured via a flange screw. A bushing, which is received in a bearing eye of the track rod, is seated on the screw with axial play.

U.S. Pat. No. 8,444,158 B2 discloses an assembly having a wheel carrier and a bushing for a suspension of a vehicle. In this case, the wheel carrier has a bearing eye, which defines a cylinder-like recess that tapers towards its ends. Arranged in the recess is a metal, bushing element, which thickens, sphere-like, in a central region and is widened in a manner of a truncated cylinder towards ends, and has a through-bore for receiving an axial bolt. A rubber-elastic element is arranged between the bushing element and the bearing eye.

In light of the demonstrated prior art, a connection of two components via a bearing bushing, for example a rubber-metal bushing, still has room for improvement. In this case, it would be particularly desirable to prevent any disadvantages caused by a tensioning of the bearing bushing.

### SUMMARY

The disclosure is based on an object that optimizes a connection of two components with a bearing bushing.

It should be pointed out that, in the description below, the individually described features and measures can be combined with one another in any technically useful manner and demonstrate further embodiments of the disclosure. The description additionally characterizes and specifies the disclosure in particular in conjunction with the Figure.

A bearing arrangement for a motor vehicle is provided by the disclosure. In particular, trucks or automobiles are possible motor vehicles. In this case, the bearing arrangement serves to connect two components of the motor vehicle to one another, wherein various degrees of freedom can enable an axial, tangential, radial and/or cardanic movement.

The bearing arrangement has a first component with a bearing eye in which a bearing bushing is arranged. The first component is normally manufactured from metal, for example from steel, cast iron or aluminum. However, other materials are also essentially conceivable, for example fiber-reinforced plastics material. The bearing eye here is a continuous opening within the first component. Depending on the embodiment, the bearing bushing can be pressed into the bearing eye, for example, so that a force-fitting connection is produced. Alternatively or additionally, however, a material-fitting connection can also be produced for example between the bearing bushing and the bearing eye.

The bearing arrangement furthermore has a second component with a first and second attaching portion that are arranged on both sides of the first component in a region of the bearing eye. The materials used for the second component can be the same as those for the first component; therefore, the second component normally consists of metal. The second component has two attaching portions, which are normally, rigidly connected to one another, although the two attaching portions can have a certain inherent elasticity. In particular, they can be connected to one another in one piece. The attaching portions are arranged on both sides, i.e. on opposite sides of the first component, in the region of the bearing eye. It could also be said that the two attaching portions oppose one another with respect to the first component, or that the first component is arranged between the attaching portions in the region of the bearing eye. In a typical embodiment, the two attaching portions can also be referred to as clevis arms. The term “attaching portion” in this connection simply means that an attachment of the second component to the first component is produced here and should otherwise not be interpreted as restrictive.

The bearing arrangement moreover has a tensioning device, which is guided axially through an inner sleeve of the bearing bushing via a shaft portion. In this case, the inner sleeve of the bearing bushing represents a bearing bushing inner part. It is normally comparatively rigid in form and can consist for example of metal or fiber-reinforced plastics material. As will be described further below, the bearing bushing can be formed as a rubber-metal bushing, wherein the inner sleeve forms an innermost part consisting of metal. The inner sleeve can be cylindrical in form, although shapes deviating from this are also conceivable. An axial direction, and therefore also a radial and tangential direction, are specified by a progression of the inner sleeve. The inner sleeve can be formed such that the inner sleeve is at least partly symmetrical with respect to an axially extending axis of symmetry.

The shaft portion here is part of the tensioning device that is guided through the inner sleeve—more precisely, through a recess thereof that is continuous in the axial direction. The shaft portion can be in particular elongated and for example cylindrical in form. The shaft portion is normally formed in one piece. Since the tensioning device serves for tensioning components, as will be explained further below, it is preferred that the tensioning device consists at least partly of a material with sufficient strength. This can be in particular a metal, for example steel.

According to the disclosure, the tensioning device tensions the inner sleeve axially against the second attaching portion, avoiding the first attaching portion, and is received with radial form fit in a first recess of the first attaching portion via a head portion. The tensioning device tensions the inner sleeve against the second attaching portion in the axial direction. That is to say, the tensioning device exerts a force couple acting on the attaching portions in the axial direction. The inner sleeve thus lies against the second attaching portion under an axial force, wherein a further component, such as a washer, can be arranged in-between. In this case, a shaft portion serves the force transmission in the axial direction. The tensioning action avoids the first attaching portion, that is to say a force flow from the tensioning device to the inner sleeve does not extend through the first attaching portion, but rather the tensioning device effectively acts directly on the inner sleeve. This has key advantages since the tensioning device therefore does not have to transmit axial forces between the two attaching portions. There is no bending of the attaching portions that could result in internal stresses and reduce their service life. In this case, a certain deformation of the second attaching portion during tensioning against the inner sleeve is possible, but of minor significance. Moreover, the tensioning force exerted by the tensioning device can act on the inner sleeve directly and with full strength, and, unlike in the prior art, is not reduced by restoring forces that would occur during deformation of the attaching portions. In this case, the inner sleeve is preferably spaced from the first attaching portion.

However, the first attaching portion also has an important function in the case of the present disclosure since the tensioning device is received with radial form fit in the first recess of the first attaching portion via the head portion. A form fit is therefore produced in the radial direction, which at least restricts a movement of the head portion (and therefore the tensioning device as a whole) relative to the first attaching portion. It could also be said that the head portion is arranged radially adjacent to an inner wall of the first recess. In this case, it is possible that a form fit is not produced between the head portion and the first attaching portion in the tangential and/or axial direction. If the axial direction is defined by an axis (for example an axis of symmetry of the inner sleeve), then the form fit prevents displacements transversely to this axis, whilst rotations about the axis are optionally possible. In this case, the term “head portion” should not be interpreted as restrictive. In general, the head portion forms an end portion of the tensioning device in the axial direction, although this is not necessarily the case. The head portion can moreover have a greater radial extent than the shaft portion.

A certain play can be produced in the radial direction, although this is negligible in relation to the dimensions of the bearing arrangement as a whole. For example, a (minimum) radial spacing between the head portion and the inner wall of the first recess can correspond to a maximum of 2%, preferably a maximum of 1%, of a radial dimension of the first recess. It goes without saying that this spacing can be direction dependent, for example a head portion with a hexagonal cross-section could be received in a recess with a circular cross-section. In this case, it is naturally sufficient if the minimum radial spacing is present in a region of the corners. In general, the form fit in the radial direction does not have to be produced on all sides; for example, a different amount of play can be produced depending on direction. However, the form fit is preferably produced on all sides so that any displacement of the head portion relative to the first attaching portion is restricted or prevented transversely to the axial direction. As already mentioned above, this does not rule out the head portion being able to rotate relative to the first attaching portion. The head portion can preferably be formed in one piece with the shaft portion. The head portion likewise preferably acts at least indirectly on the inner sleeve with the above-mentioned tensioning force.

Owing to the form fit in the radial direction, the first attaching portion can absorb radial bearing forces, at least proportionally, i.e. the first attaching portion supports the head portion and therefore the tensioning device as a whole. The tensioning device in turn absorbs bearing forces since the tensioning device connects the inner sleeve and the second attaching portion to one another. As a result of the head portion being supported at least temporarily on the first attaching portion, it goes without saying that there is a loading and also a certain deformation of the attaching portion. However, an effect of this on the service life is generally less disadvantageous than an axial deformation that occurs in the prior art when the attaching portions are tensioned against one another.

According to a preferred embodiment, the shaft portion and the head portion are formed by a screw, which is arranged with some portions in a second recess of the second attaching portion. It goes without saying that the head portion here is the screw head. It can have a circular cross-section, but also a different, for example hexagonal, cross-section. In the case of a circular cross-section, a wide variety of drives can be provided on the head, for example a slot, a cross-head, a hexagon socket etc. The shaft of the screw, which forms the shaft portion, projects axially beyond the inner sleeve into the said second recess. According to one embodiment, the second recess can have an internal thread into which the screw is screwed. In this case, the second recess can also be formed as a blind hole, for example. Like the first recess, the second recess can be approximately flush with a continuous recess of the inner sleeve.

The first recess and/or the second recess are preferably formed continuously in the axial direction. In the case of the first recess, this is advantageous since the head portion is also accessible from a side of the first attaching portion that is remote from the first component and, for example, in the above-mentioned embodiment, the screw can also be introduced into the first recess from this side. This facilitates the assembly of the bearing arrangement considerably. In the case of the second recess, it can be advantageous, for example, that the screw can be guided completely through the second attaching portion, and is therefore screwed into an internal thread over a maximum possible length, for example.

In this connection, it is preferred that an internal cross-section of the first recess corresponds at least to a maximum external cross-section of the screw. It goes without saying that, in this case, a maximum external cross-section is produced in a region of a head of the screw. To enable the head to be introduced into the first recess (or guided through this), it goes without saying that an internal cross-section of said recess has to be selected to be somewhat greater than the maximum external cross-section of the screw.

As already mentioned above, the head portion preferably serves to act on the inner sleeve at least indirectly in the axial direction. In this case, the head portion normally protrudes in relation to the shaft portion, that is to say the head portion has a greater external dimension in the radial direction. This is then the case, for example, when the head portion and the shaft portion are formed by a screw, as described above. It is therefore preferred that a radial internal dimension of the first recess is greater than a radial internal dimension of the second recess. This is explained in that the first recess serves to receive the head portion whilst the second recess can serve to receive an end of a screw, for example.

As already mentioned, it would be conceivable that the second recess has an internal thread into which the screw is screwed. According to an alternative embodiment, the screw cooperates with a nut that is arranged on a side of the second attaching portion that is opposite the first attaching portion. In this case, it is in particular provided that the nut screwed to the screw acts at least indirectly on the second attaching portion. That is to say, when the bearing arrangement is assembled, the inner sleeve can firstly be arranged between the two attaching portions, and the screw can be guided through the attaching portions and through the inner sleeve. In the region of the second attaching portion, the nut is screwed onto the screw (wherein a washer or the like can be arranged in-between) until it lies against the second attaching portion. By tightening the nut and the screw against one another, the tensioning force is generated between the second attaching portion and the inner sleeve. The nut can optionally be a flange nut. In this embodiment, an internal thread is not normally arranged on the second recess and the second recess can be dimensioned in particular such that the screw is arranged at a spacing therein.

It is possible to provide a further portion between the head portion and the shaft portion, which further portion lies against, and acts on, the inner sleeve. Such a portion of the tensioning device can possibly also be formed as a separate component, for example as a washer. According to a structurally simple embodiment, however, the head portion lies directly against the inner sleeve. That is to say the head portion acts on the inner sleeve directly in the axial direction. It goes without saying that, to this end, a radial external dimension of the head portion has to be greater than a radial internal dimension of the inner sleeve.

As already mentioned above, the head portion can be rotatable with respect to the first recess. If the tensioning device has a screw and a nut, the screw can be held for example by a screwdriver for tensioning purposes, whilst the nut is held by a wrench or the like. According to an alternative embodiment, the head portion is received in the first recess in a torsion-resistant manner. That is to say a tangential form fit is also produced in addition to the radial form fit. This can be realized for example in that the head portion is formed as a hexagon and the first recess likewise has a hexagonal cross-section corresponding thereto. It goes without saying that a wide variety of different options are conceivable to ensure torsion-resistance. For example, a securing pin could therefore also be guided through the first attaching portion and the head portion.

The bearing arrangement according to the disclosure can be used in different regions of a motor vehicle. However, the first and the second component preferably belong to a suspension of the motor vehicle. The suspension here includes all of the parts that serve for connecting at least one vehicle wheel to a vehicle body (chassis, body shell and/or subframe). In this case, at least one of these parts can also be associated with a vehicle body itself. In this regard, the components can also be referred to as suspension parts in this case. In particular, the first component can be formed as a suspension control arm. This can essentially be any known type of control arm, for example a longitudinal control arm or transverse control arm. The second suspension part can be a subframe, for example, on which the suspension control arm is arranged, or in particular a wheel carrier that is normally connected to the vehicle body via a plurality of control arms.

As already mentioned above, the bearing bushing can be formed in particular as a rubber-metal bushing. In this case, the bearing bushing has a rubber element surrounding the inner sleeve. It could also be said that the rubber element is arranged concentrically around the inner sleeve. It can preferably be formed at least partly symmetrically to an axial axis of symmetry of the inner sleeve, although an asymmetrical, for example eccentric, design would also be conceivable. The rubber element can also be referred to as a rubber-elastic element and does not necessarily have to consist of rubber, but can also be formed from an elastic material with comparable properties, e.g. silicone. The rubber element is normally formed in one piece, although a multi-piece form is also conceivable, or a plurality of rubber elements can be present. The rubber element lies against the inner sleeve, at least in some portions, and can create a form fit, possibly also a material fit, with this. This elasticity of the rubber element is considerably greater than that of the inner sleeve so that forces acting on the rubber element primarily result in a deformation thereof, but, at most, a negligible deformation of the inner sleeve. The rubber element serves for at least indirect connection to a first component, i.e. the rubber element can be pressed or glued directly into a recess of the first component, for example, or connected thereto in another manner.

Alternatively, the rubber element can in turn be surrounded by an outer sleeve that, like the inner sleeve, is formed to be inelastic and can likewise consist of metal, for example. This outer sleeve can be arranged in the bearing eye of the first component, for example by being pressed therein. In any case, a limited movability of the first component in relation to the inner sleeve is produced as a result of an elasticity of the rubber element. In particular, an axial, radial, tangential and cardanic movement can be possible. In this case, overall construction of the bearing bushing corresponds to a composite bearing, more precisely a rubber-metal bearing. In this case, the bearing bushing can also be designed in a manner of a hydraulic bushing, wherein, apart from the rubber element, one or more mutually connected chambers in which a fluid is enclosed are also provided between the inner sleeve and the outer sleeve. A damping behavior can thus be considerably improved or refined in relation to a rubber-metal bushing.

Further advantageous details and effects of the disclosure is explained in more detail below with reference to an exemplary embodiment illustrated in the Figure.

### BRIEF DESCRIPTION OF THE DRAWINGS

FIG. 1 a partial sectional illustration of a first embodiment of a bearing arrangement according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

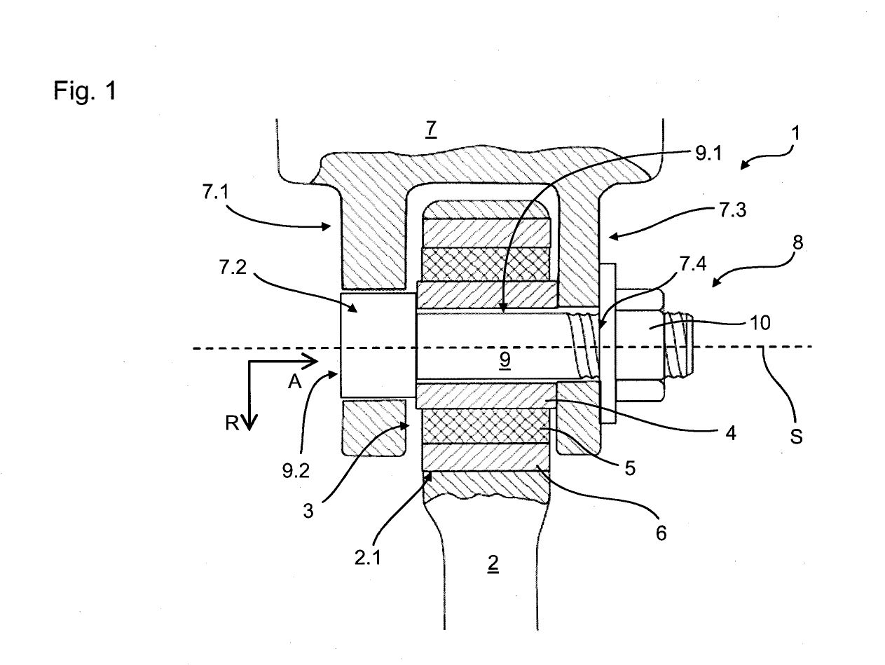

FIG. 1 shows a partial, sectional illustration of a bearing arrangement 1 according to the disclosure, which can be part of a wheel suspension of an automobile, for example. In this case, a transverse control arm 2 is movably connected to a wheel carrier 7. The transverse control arm 2 has a bearing eye 2.1 at an end, into which a bearing bushing 3 is pressed, which, in the present case, is formed as a rubber-metal bushing. In this case, an outer sleeve 6 consisting of metal lies directly against the transverse control arm 2 within the bearing eye 2.1. This outer sleeve 6 concentrically surrounds an inner sleeve 4, likewise consisting of metal, wherein a rubber element 5 is arranged between the two sleeves 4, 6. In the present case, both sleeves 4, 6, like the rubber element 5, are constructed cylinder-symmetrically to an axis of symmetry S that extends in an axial direction A.

The wheel carrier 7 has a first attaching portion 7.1 and a second attaching portion 7.3, which are arranged opposite one another with respect to the transverse control arm 2. The attaching portions 7.1, 7.3 could also be referred to as clevis arms. A first recess 7.2 is formed within the first attaching portion 7.1, and a second recess 7.4 is formed within the second attaching portion 7.3. Both recesses 7.2, 7.4 are formed continuously in the axial direction A, and have a circular cross-section. In this case, a diameter of the first recess 7.2 is dimensioned to be considerably greater than a diameter of the second recess 7.4.

The attachment of the transverse control arm 2 to the wheel carrier 7 via the bearing bushing 3 takes place via a tensioning device 8 that, in the present example, comprises a screw 9 and a flange nut 10. The screw 9 is guided through the inner sleeve 4 via a shaft portion 9.1, and projects through the second recess 7.4 to a side of the second attaching portion 7.3 that is opposite the first attaching portion 7.1, where the screw 9 is secured via the flange nut 10. In this case, the screw 9 is arranged with play within the second recess 7.4. A head 9.2 of the screw 9, which can have a hexagon socket or other drive, for example, is received within the first recess 7.2, wherein a form fit is produced in a radial direction R. To enable introduction of the head 9.2 into the first recess 7.2, a slight, radial spacing is provided, which, in the present case however, is less than 1% of a radius of the first recess 7.2. In this case, a size of the radial spacing between the head 9.2 and the first attaching portion 7.1 is exaggerated in FIG. 1 and not shown to scale.

The head 9.2 lies against the inner sleeve 4 in the axial direction A. By tightening the flange nut 10 and the screw 9 against one another, an axially acting tensioning force is generated, through which the inner sleeve 4 is tensioned against the second attaching portion 7.3. Whilst the inner sleeve 4 therefore lies against the second attaching portion 7.3, the inner sleeve 4 is spaced from the first attaching portion 7.1. The tensioning in the axial direction A takes place avoiding the first attaching portion 7.1, so that no bending moments act on the attaching portions 7.1, 7.3.

Owing to the head 9.2 being received within the first recess 7.2 with form fit, any possible radial forces that act on the screw 9 on a part of the bearing bushing 3 are absorbed by the first attaching portion 7.1. This therefore contributes significantly to stabilization, even though it is not tensioned against the inner sleeve 4. On a part of the second attaching portion 7.3, radial forces are absorbed via a force fit between the inner sleeve 4 and the second attaching portion 7.3, and by a force fit between the flange nut 10 and the attaching portion 7.3. The inner sleeve 4 is therefore secured as a whole in the axial direction A and in the radial direction R. In some circumstances, however, a rotation in a tangential direction could occur. To prevent rotation in the tangential direction, instead of a head 9.2 with a circular cross-section, the screw 9 may be provided with a hexagonal head, for example, wherein the first recess 7.2 has a likewise hexagonal cross-section corresponding thereto.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A bearing arrangement for a motor vehicle comprising:
a first component with a bearing eye, in which a bearing bushing is arranged;
a second component with a first and second attaching portion, arranged on both sides of the first component in a region of the bearing eye; and
a tensioning device guided axially through an inner sleeve of the bearing bushing via a shaft portion, wherein the tensioning device tensions the inner sleeve axially against the second attaching portion, avoiding the first attaching portion, and is received with a radial, form fit in a first recess of the first attaching portion with a head portion.

2. The bearing arrangement as claimed in claim 1, wherein the shaft portion and the head portion are formed by a screw being arranged with some portions in a second recess of the second attaching portion.

3. The bearing arrangement as claimed in claim 2, wherein the first recess and the second recess are formed continuously in an axial direction.

4. The bearing arrangement as claimed in claim 2 wherein, the first recess defines an internal cross-section that corresponds at least to a maximum external cross-section of the screw.

5. The bearing arrangement as claimed in claim 1, wherein the first recess defines a radial internal dimension that is greater than a radial internal dimension of the second recess.

6. The bearing arrangement as claimed in claim 2, wherein the screw cooperates with a nut that is arranged on a side of the second attaching portion being opposite the first attaching portion.

7. The bearing arrangement as claimed in claim 1, wherein the head portion lies directly against the inner sleeve.

8. The bearing arrangement as claimed in claim 1, wherein the head portion is received in the first recess in a torsion-resistant manner.

9. The bearing arrangement as claimed in claim 1, wherein the first component is formed as a suspension control arm and the second component is formed as a wheel carrier.

10. The bearing arrangement as claimed in claim 1, wherein the bearing bushing has a rubber element surrounding the inner sleeve.

11. A vehicle comprising:
a control arm with a bushing arranged within a bearing eye;
a wheel carrier with first and second clevis arms on the control arm; and
a screw guided through the bushing via a shaft such that a sleeve is axially tensioned against the second clevis arm, the screw avoiding the first clevis arm and including a head received with a radial, form fit in a first recess of the first clevis arm.

12. The vehicle as claimed in claim 11, wherein the first recess and a second recess of the second clevis arm are formed continuously in an axial direction.

13. The vehicle as claimed in claim 12, wherein the first recess defines a radial internal dimension that is greater than a radial internal dimension of the second recess.

14. The vehicle as claimed in claim 11, wherein the first recess defines an internal cross-section that corresponds to a maximum, external cross-section of the screw.

15. The vehicle as claimed in claim 11, wherein the head lies directly against the sleeve.

16. A vehicle suspension comprising:
a control arm with a bushing arranged within a bearing eye;
a wheel carrier with first and second clevis arms arranged on the control arm; and
a screw guided through the bushing such that the sleeve is axially tensioned against the second clevis arm, wherein the screw avoids the first clevis arm and includes a head received with a radial, form fit in a first recess of the first clevis arm.

17. The vehicle suspension as claimed in claim 16, wherein the first recess and a second recess of the second clevis arm are formed continuously in an axial direction.

18. The vehicle suspension as claimed in claim 17, wherein the first recess defines a radial internal dimension that is greater than a radial internal dimension of the second recess.

19. The vehicle suspension as claimed in claim 16, wherein the first recess defines an internal cross-section that corresponds to a maximum, external cross-section of the screw.

20. The vehicle suspension as claimed in claim 16, wherein the head lies directly against the sleeve.
